(19) United States
(12) Patent Application Publication
(10) Pub. No.: US 2026/0311433 A1
(43) Pub. Date: Oct. 8, 2026

(54) OBJECT MODELING WITH TENSOR PRODUCTS

(71) Applicants: Sela Dombrower, Boulder, CO (US); Alyn Rockwood, Boulder, CO (US)

(72) Inventors: Sela Dombrower, Boulder, CO (US); Alyn Rockwood, Boulder, CO (US)

(21) Appl. No.: 19/546,374

(22) Filed: Feb. 22, 2026

Related U.S. Application Data
(60) Provisional application No. 63/782,241, filed on Apr. 2, 2025.

(51) Int. Cl. G06T 17/30

(52) U.S. Cl. CPC G06T 17/30; G06T 2210/52

(57) ABSTRACT

A computer-implemented method for evaluating a curve element of a 3D model includes providing a description of the curve element including a Bernstein basis and one or more control point vectors, evaluating polynomial basis vectors corresponding with the Bernstein basis at a plurality of first parameter steps to produce a matrix of power basis vectors, computing a curve matrix from the product of a Bernstein basis and a matrix of the control point vectors and evaluating the curve at the first parameter steps by computing the product of the matrix of power basis vectors and the curve matrix. Methods for evaluating a curve element of a 3D model may be extended or scaled to higher dimensional elements so that surfaces may be evaluated.

### CROSS-REFERENCE TO RELATED APPLICATIONS

The disclosure claims the benefit of and incorporates herein by reference in its entirety U.S. Provisional Application 63/782,241 entitled ‘OBJECT MODELING WITH TENSOR PRODUCT SURFACES’, filed 2 Apr. 2025, pending.

### SUMMARY

The disclosure describes a computer-implemented method for evaluating a curve element of a 3D model. The method includes multiplying a basis matrix having vector coefficient rows by a curve element control point matrix having vector rows to obtain a control point basis matrix having vector rows, evaluating a polynomial basis vector at a number of parameter steps to produce a polynomial basis matrix having vector rows and multiplying the polynomial basis matrix having vector rows by the control point basis matrix having vector rows to obtain a curve element point matrix having vector rows.

The disclosure also describes a computer-implemented method for evaluating a surface element of a 3D model. The method includes multiplying a basis matrix having vector coefficient rows by a tensor of surface element control point matrices having vector rows to obtain a tensor of surface element control point matrices having basis-changed vector rows, multiplying the tensor of surface element control point matrices with basis-changed rows by the basis matrix having vector coefficient rows to obtain a tensor of control point vector row matrices in the basis, evaluating a polynomial basis vector at a number of steps in a first parameter to produce a matrix of polynomial basis vector rows of the first parameter, evaluating the polynomial basis vector at a number of steps in a second parameter to produce a matrix of polynomial basis vector rows of the second parameter, multiplying the matrix of polynomial basis vector rows of the first parameter by the tensor of control point vector row matrices in the basis to obtain an intermediate result tensor having vector rows and multiplying the intermediate result tensor having vector rows by the matrix of polynomial basis vector rows of the second parameter to obtain a tensor of surface element point matrices having vector rows.

Further, the disclosure describes a system for evaluating a curve element of a 3D model. The system includes a memory, a storage containing a curve element control point matrix having vector rows and a basis matrix having vector coefficient rows and a processor having a plurality of cores configured for parallel processing. The processor is configured to multiply a basis matrix having vector coefficient rows by the curve element control point matrix having vector rows to obtain a control point basis matrix having vector rows, to evaluate a polynomial basis vector at a number of parameter steps to produce a polynomial basis matrix having vector rows and to multiply the polynomial basis matrix having vector rows by the control point basis matrix having vector rows to obtain a curve element point matrix having vector rows.

Further still, the disclosure describes a system for evaluating a surface element of a 3D model. The system includes a memory, a storage containing a tensor of control point matrices having vector rows and a processor having a plurality of cores configured for parallel processing. The processor is configured to multiply a basis matrix having vector coefficient rows by the tensor of surface element control point matrices having vector rows to obtain a tensor of surface element control point matrices having basis-changed vector rows, multiply the tensor of surface element control point matrices with basis-changed vector rows by the basis matrix having vector coefficient rows to obtain a tensor of surface element control point vector row matrices in the basis, evaluate a polynomial basis vector at a number of steps in a first parameter to produce a matrix of polynomial basis vector rows of the first parameter, evaluate the polynomial basis vector at a number of steps in a second parameter to produce a matrix of polynomial basis vector rows of the second parameter, multiply the matrix of polynomial basis vector rows of the first parameter by the tensor of surface element control point vector row matrices in the basis to obtain an intermediate result tensor having vector rows and multiply the intermediate result tensor having vector rows by the matrix of polynomial basis vector rows of the second parameter to obtain a tensor of surface element control point matrices having vector rows.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those of skill in the art will understand that the drawings are not to scale. Wherever possible, like elements have been indicated by identical numbers.

Embodiments of the present disclosure will now be described, by way of example only, with reference to the following diagrams wherein:

FIG. 1 illustrates an example method for evaluating a curve element of a 3D model.

FIG. 2 illustrates an example curve element control point matrix having vector rows.

FIG. 3 illustrates an example basis matrix having vector coefficient rows.

FIG. 4 illustrates an example control point basis matrix having vector rows.

FIG. 5 illustrates an example polynomial basis matrix having vector rows.

FIG. 6 illustrates an example curve element point matrix having vector rows.

FIG. 7 illustrates a rendering of a curve element produced in association with disclosed curve element evaluation methods and systems.

FIGS. 8A & 8B illustrate an example method for evaluating a surface element of a 3D model.

FIG. 9 illustrates an example tensor of surface element control point matrices having vector rows.

FIG. 10 illustrates an example tensor surface element control point matrices having basis-changed rows.

FIG. 11 illustrates an example tensor of control point basis matrices having vector rows.

FIG. 12 illustrates an example intermediate result tensor.

FIG. 13 illustrates an example tensor of surface element point matrices having vector rows.

FIG. 14 illustrates a rendering of a surface element produced in association with disclosed surface element evaluation methods.

FIG. 15 schematically illustrates various components of an example computing system suitable for use in association with disclosed methods for evaluating a curve element or surface element of a computer model.

### DETAILED DESCRIPTION

The following detailed description illustrates embodiments of the present disclosure and manners by which they can be implemented. Although the best mode of carrying out the present disclosure has been described, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Current state-of-the-art modeling algorithms in computer-aided design (CAD) and computer-aided modeling (CAM) use serial processors such as central processing units (CPU) for NURBS evaluations. NURBS can be converted to Bezier forms in order to utilize the stability and precision of the Bernstein bases in evaluation. Nested tensors loaded into a parallel or tensor-core processing unit such as a graphics processing unit (GPU) may be used to speed up computation and avoid explicit loops. This approach not only speeds up evaluations but makes them more accurate. Embodiments of the present disclosure provide computer-implemented methods optimized to capitalize on GPU capabilities such as parallel computing, high-speed matrix calculations, and fused multiply-adds.

Many GPUs also have tensor cores. Libraries such as Tensorflow and Pytorch allow easy CPU-GPU distribution. Bezier forms can be formulated as a matrix of vector coefficients, a tensor, multiplied by the vector of basis functions and, ultimately, as Torch tensors. Storing parameter values inside nested tensors wherein each inner-most tensor is a power-basis vector for a single parameter allows the parameter values to be sent to the GPU to avoid having to fetch them repeatedly. Torch includes logic to iterate over the tensors to perform matrix multiplication in a manner that eliminates the need for explicitly programmed loops.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

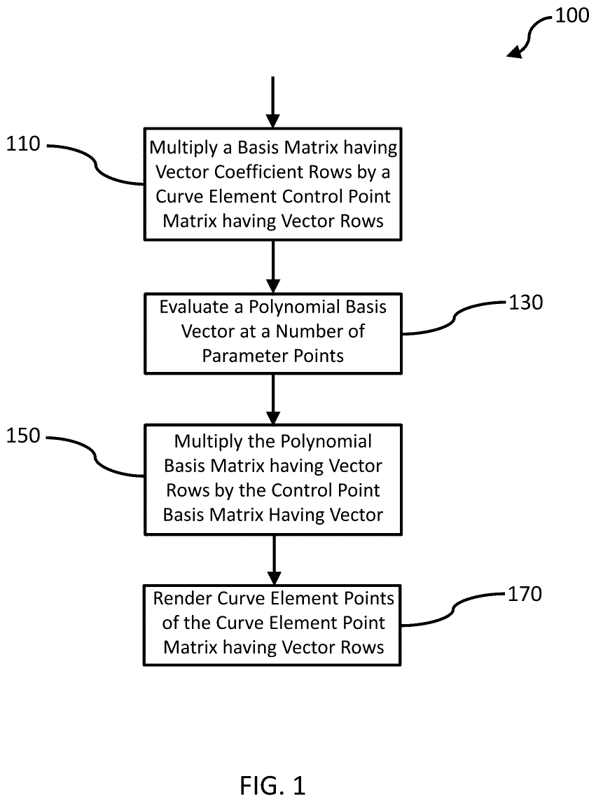

Referring now to the drawings, particularly by their reference numbers FIG. 1 illustrates actions of an example computer-implemented method 100 for evaluating a curve element of a 3D model in accordance with an embodiment of the present disclosure. The method is depicted as a collection of actions in a logical flow diagram, which represents a sequence of actions that may be implemented in hardware, software, or a combination thereof.

A Bezier description of the curve element is provided including a number of control points or control point vectors. The Bezier description may be provided by converting a NURBs description, a Ferguson description, a Hermite description, a Catmull-Rom description, a Lagrange description of the curve element or a combination of these into the Bezier description.

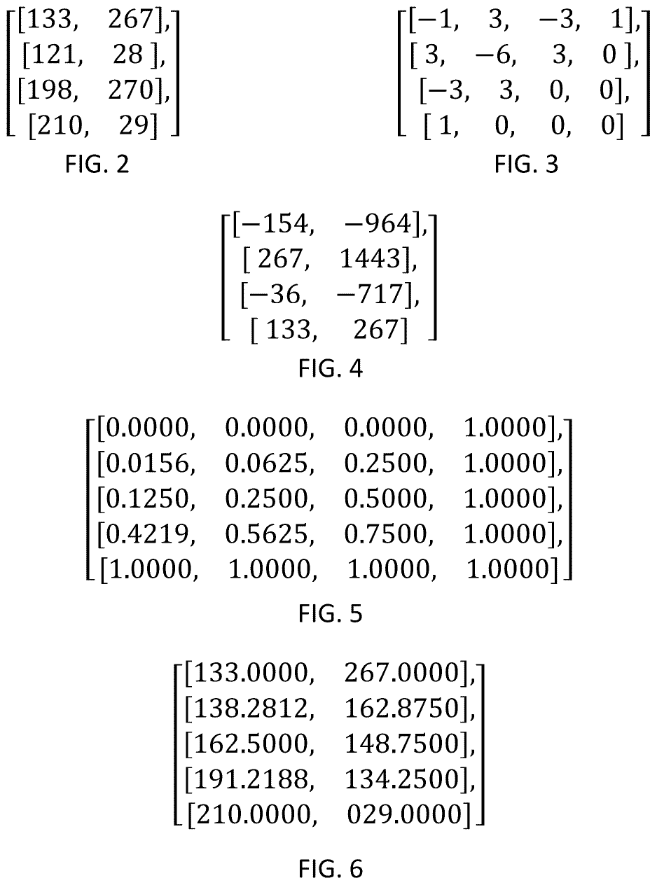

The method includes multiplying a basis matrix having vector coefficient rows by a curve element control point matrix having vector rows at 110 to obtain a control point basis matrix having vector rows. While the curve element control point matrix having vector rows will be given, an example of the same is shown in FIG. 2.

Example computer instructions for loading the tensor of control point matrices having vector rows, as written in python include:

cubic_controls = torch.tensor([
[133., 267], [121, 28], [198, 270], [210, 29]
]).float( )

While any of a variety of basis vector coefficients may be used depending on the desired evaluation speed, precision and number of starting control points, in an example for four control points, a Bernstein basis for a cubic curve is used, shown by way of example in FIG. 3.

Example computer instructions for loading a basis matrix having vector coefficient rows, as written in python include:

bern_basis_cubic = torch.tensor([[−1, 3, −3, 1], [3, −6, 3, 0], [−3, 3, 0, 0], [1, 0, 0,
0]]).float( )

The control point basis matrix having vector rows, as shown by example in FIG. 4, is obtained by multiplying the example basis matrix having vector coefficient rows by the example curve element control point matrix having vector rows.

Multiplying the basis matrix having vector coefficient rows by the curve element control point matrix having vector rows may further include obtaining one or more components of the control point basis matrix having vector rows in parallel with or contemporaneously with obtaining one or more other components of the control point basis matrix having vector rows.

Example computer instructions for multiplying the basis matrix having vector coefficient rows by the curve element control point matrix having vector rows as written in python include:

$$controls\_with \_bernstein = torch . matmul ( bern\_basis \_cubic , cubic\_controls )$$

At 130, a polynomial basis vector is evaluated at a number of parameter steps to produce a polynomial basis matrix having vector rows. The polynomial basis vector will be suitable for the chosen basis. An example polynomial basis vector of degree three is (t³, t², t, 1).

While any number of parameters steps suitable to render a curve which will appear to be smooth to the user may be used, in a simple example, five parameter steps, 0.000, 0.250, 0.500, 0.750 and 1.0, are used. As such the polynomial basis matrix having vector rows of degree 3 evaluated at the parameter steps is shown by example in FIG. 5.

Evaluating the polynomial basis vector at the parameter steps may further include evaluating the polynomial basis vector at one of the parameter steps in parallel with or contemporaneously with evaluating the polynomial basis vector at another of the parameter steps. Alternatively, the polynomial basis vector may be evaluated at the parameter steps in a series of loops or cycles and/or the components of the polynomial basis vector maybe evaluated in a series of loops.

Example computer instructions for evaluating the polynomial basis vector at these five parameter steps, as written in python include:

```
def t_steps_fcn(start, end, step):
    num = np.linspace(start, end, (end-start)
      *int(1/step)+1).tolist( )
    t_steps = [round(i, 2) for i in num]
    return t_steps
t_vector = t_steps_fcn(0,1,0.25)
power_torch_array = torch.tensor([ ])
for t in t_vector:
  power_basis = torch.tensor([[t**3,t**2,t, 1]])
  power_torch_array=torch.cat((power_torch_array,power_basis),0)
```

The polynomial basis matrix having vector rows is multiplied by the control point basis matrix having vector rows at 150 to obtain a curve element point matrix having vector rows. Multiplying the polynomial basis matrix having vector rows shown by example in FIG. 5 by the control point basis matrix having vector rows shown by example in FIG. 4 yields points on the curve element curve expressed as curve element point matrix having vector rows as shown by example in FIG. 6.

The multiplying the polynomial basis matrix having vector rows by the control point basis matrix having vector rows may further include obtaining one or more components of the curve element point matrix in parallel with or contemporaneously with obtaining one or more other components of the curve element point matrix having vector rows. Example computer instructions for multiplying the polynomial basis matrix having vector rows by the control point basis matrix having vector rows, as written in python include:

$$points\_on \_curve = torch . matmul ( power\_torch \_array , controls\_with \_bernstein )$$

Multiplying the basis matrix having vector coefficient rows by the curve element control point matrix having vector rows may be performed in parallel with or contemporaneously with the evaluating the polynomial basis vector at the number of parameter steps. The product of the basis matrix having vector coefficient rows and the curve element control point matrix having vector rows may be computed by performing fused multiply-adds and/or such that a plurality of multiplications are performed in a multiply operation and the results are added in an accumulation operation. Similarly, the product of the polynomial basis matrix having vector rows and the control point basis matrix having vector rows may be computed by performing fused multiply-adds.

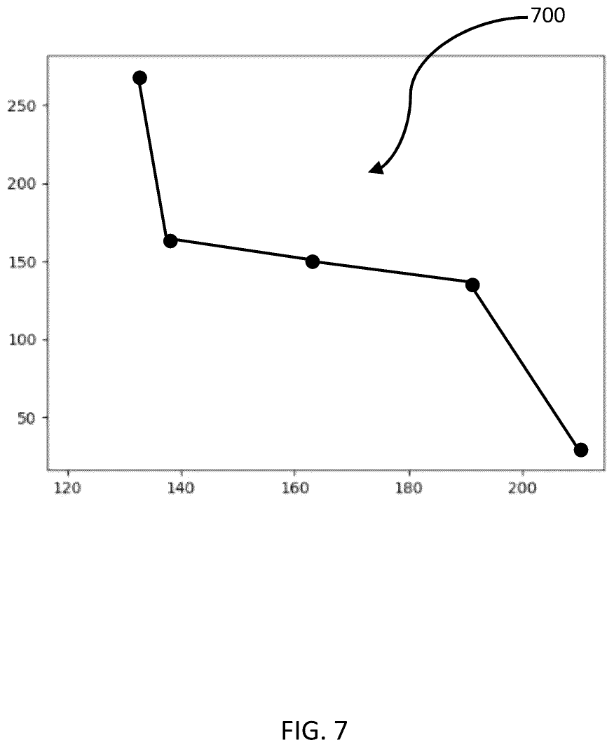

The method may further include, at a display, rendering curve element points of the curve element point matrix having vector rows at 170. FIG. 7 illustrates the evaluated curve points 700 connected by line segments and rendered as graphics. The actions described with reference to FIG. 1 are merely examples and other alternatives can also be provided where one or more actions are added, one or more actions are removed, or one or more actions are provided in a different sequence without departing from the scope of the claims herein.

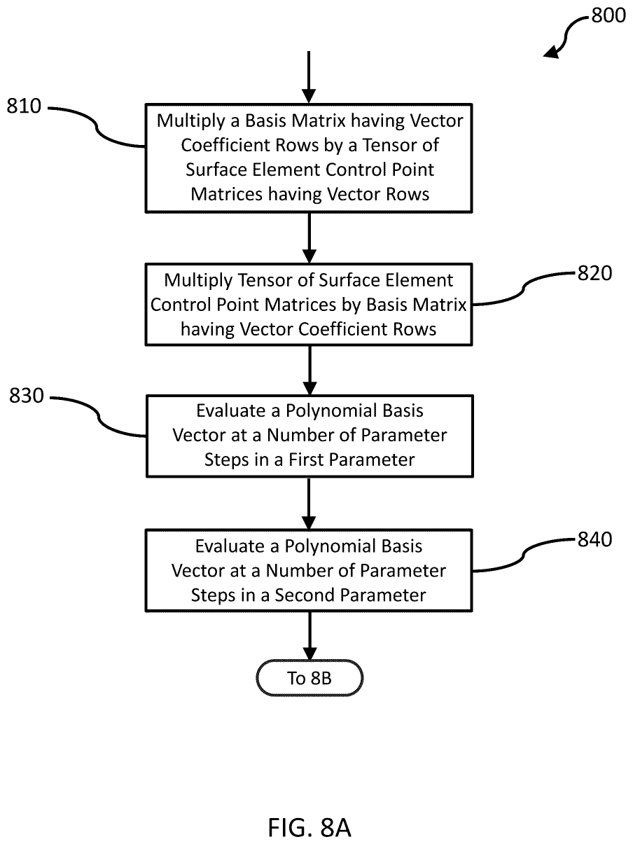

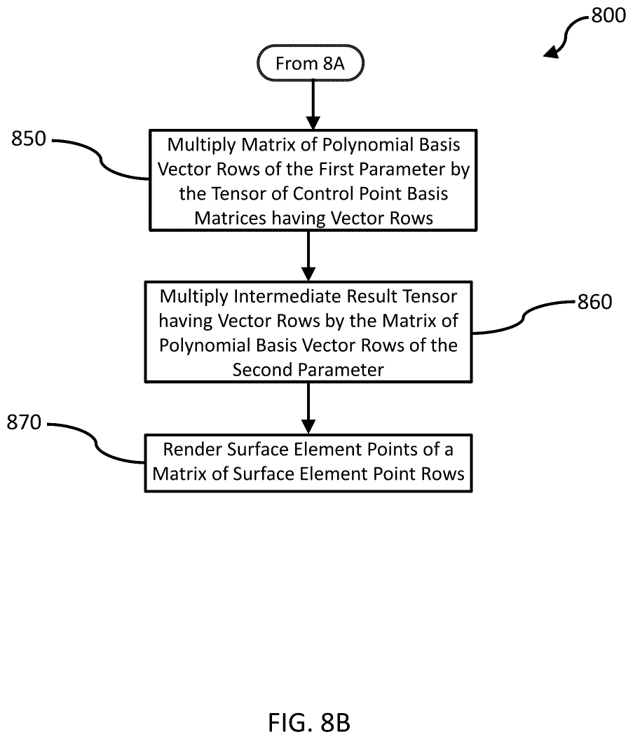

It will be appreciated that described methods for evaluating a curve element of a 3D model may be extended or scaled to higher dimensional elements. For example, surfaces may be evaluated by extended or scaled methods. FIGS. 8A & 8B illustrate actions of an example computer-implemented method 800 for evaluating a surface element of a 3D model in accordance with an embodiment of the present disclosure. The method is depicted as a collection of actions in a logical flow diagram, which represents a sequence of actions that may be implemented in hardware, software, or a combination thereof.

At 810, a basis matrix having vector coefficient rows is multiplied by a tensor of surface element control point matrices having vector rows to obtain a tensor of surface element control point matrices having basis-changed vector rows.

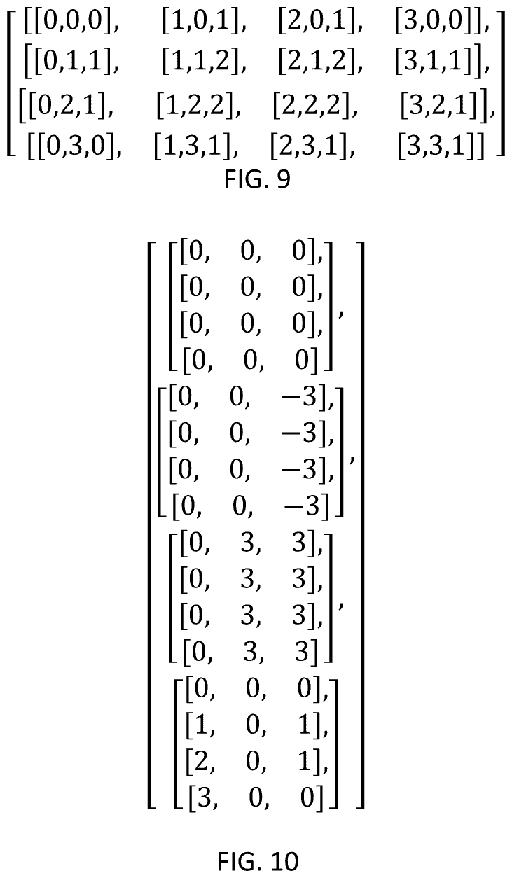

While the tensor of control point matrices having vector rows will be given in accordance with the particular surface element being evaluated, an example tensor is shown in FIG. 9.

Example computer instructions for loading the tensor of control point matrices having vector rows, as written in python include:

```
surface_controls = torch.tensor([
  [[0, 0, 0], [1, 0, 1], [2, 0, 1], [3, 0, 0]],
  [[0, 1, 1], [1, 1, 2], [2, 1, 2], [3, 1, 1]],
  [[0, 2, 1], [1, 2, 2], [2, 2, 2], [3, 2, 1]],
  [[0, 3, 0], [1, 3, 1], [2, 3, 1], [3, 3, 0]]
]).float( )
```

Given four control points in each of the \hat{ι} and ĵ directions, a suitable example basis matrix having vector coefficient rows describes the Bernstein basis for a cubic curve. Again, this matrix is illustrated by example in FIG. 3.

As mentioned above, example computer instructions for loading a basis matrix having vector coefficient rows, as written in python include:

bern_basis_cubic = torch.tensor([[−1, 3, −3, 1], [3, −6, 3, 0], [−3, 3, 0, 0], [1, 0, 0,
0]]).float( )

Example computer instructions for multiplying the basis matrix having vector coefficient rows by a tensor of surface element control point matrices having vector rows to obtain a tensor of surface element control point matrices having basis-changed vector rows, as written in python include:

$$P 1 = torch . einsum {(}^{′} ij , jkc -> {ikc}^{′} , bern\_basis \_cubic , surface\_controls )$$

The resulting tensor of surface element control point matrices having basis-changed vector rows is shown by example in FIG. 10.

Multiplying the basis matrix having vector coefficient rows by the tensor of control point matrices having vector rows may be undertaken by obtaining one or more components of the tensor of control point matrices having basis-changed vector rows in parallel with or contemporaneously with obtaining one or more other components of the tensor of control point matrices having basis-changed vector rows.

The tensor of surface element control point matrices with basis-changed rows is multiplied by the basis matrix having vector coefficient rows at 820 to obtain a tensor of control point basis matrices having vector rows.

Example computer instructions for multiplying the tensor of surface element control point matrices with basis-changed rows by the basis matrix having vector coefficient rows, as written in python include:

control_points_wrt_bernstein_power_basis = torch.einsum(‘ikc,kj->ijc’, P1,
bern_basis_cubic)

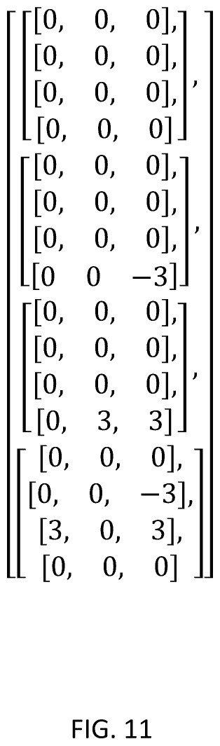

Given the example control point grid, and use of the Bernstein basis, the resulting tensor of control point basis matrices having vector rows is shown by example in FIG. 11.

Multiplying the tensor of control points with basis-changed rows by the basis matrix having vector coefficient rows may be undertaken by obtaining one or more components of the tensor of control point basis matrices having vector rows in parallel with or contemporaneously with obtaining one or more other components of the tensor of control point basis matrices having vector rows.

The polynomial basis vector is evaluated at a number of steps in a first parameter at 830 to produce a polynomial basis matrix having vector rows of the first parameter shown by example in FIG. 5. The polynomial basis vector is also evaluated at a number of steps in a second parameter at 840 to produce a polynomial basis matrix having vector rows of the second parameter the values of which are also shown by example in FIG. 5.

The polynomial basis vector may be evaluated at one of the parameter steps in the first parameter space in parallel with or contemporaneously with evaluating the polynomial basis vector at another of the parameter steps. Similarly, the polynomial basis vector may be evaluated at one of the parameter steps in the second parameter space in parallel with or contemporaneously with the evaluating the polynomial basis vector at another of the parameter steps. Further, the polynomial basis vector may be evaluated at one of the parameter steps in the first parameter space in parallel with or contemporaneously with the evaluating of the polynomial basis vector at one of the parameter steps in the second parameter space.

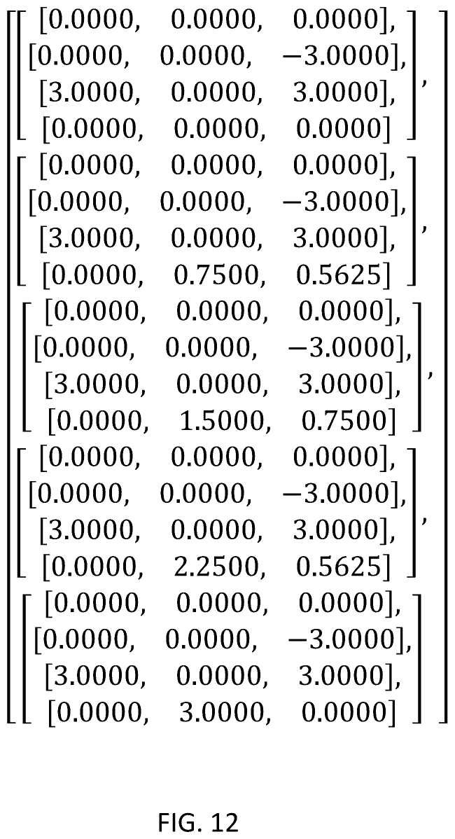

The matrix of polynomial basis vector rows of the first parameter is multiplied by the tensor of control point basis matrices having vector rows at 850 to obtain an intermediate result tensor having vector rows illustrated by way of example in FIG. 12.

Multiplying the matrix of polynomial basis vector rows of the first parameter by the tensor of control point vector row matrices in the basis may be undertaken by obtaining one or more components of the intermediate result tensor having vector rows in parallel or contemporaneously with obtaining one or more other components of the intermediate result tensor having vector rows. Example computer instructions for multiplying the polynomial basis matrix having vector rows of the first parameter by the tensor of control point basis matrices having vector rows, as written in python include:

M = control_points_wrt_bernstein_power_basis
tmp = torch.einsum(‘mu,uvk->mvk’, u_vec, M)

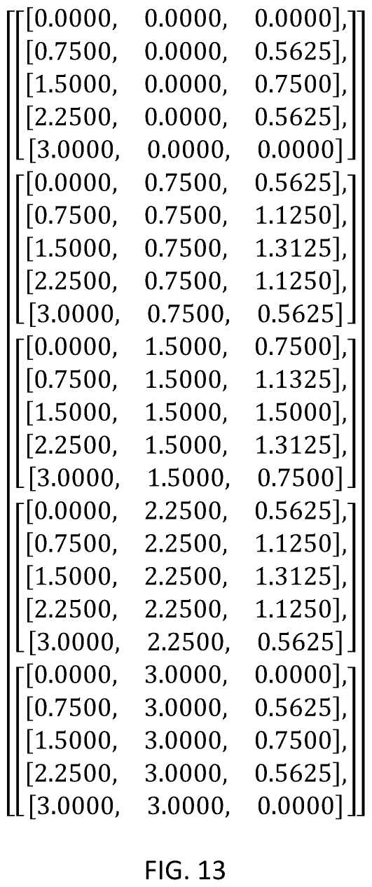

The intermediate result tensor having vector rows is multiplied by matrix of polynomial basis vector rows of the second parameter at 860 to obtain a tensor of surface element point matrices having vector rows. An example tensor of surface element point matrices having vector rows is shown in FIG. 13.

Multiplying the intermediate result tensor having vector rows by the matrix of polynomial basis vector rows of the second parameter may be undertaken by obtaining one or more components of the tensor of surface element point matrices having vector rows in parallel with or contemporaneously with obtaining one or more other components of the tensor of surface element point matrices having vector rows. Example computer instructions for multiplying the intermediate result tensor having vector rows by the polynomial basis matrix having vector rows of the second parameter include:

$$surface\_pts = torch . einsum {(}^{′} mvk , nv -> mnk ’ , tmp , v\_vec )$$

As an example alternative to obtaining an intermediate result tensor having vector rows by multiplying the matrix of polynomial basis vector rows of the first parameter by the tensor of control point vector row matrices and then multiplying the intermediate result tensor by the matrix of polynomial basis vector rows of the second parameter, the matrix of polynomial basis vector rows of the first parameter may be multiplied by the matrix of polynomial basis vector rows of the second parameter in an outer product and the result may then be multiplied by the tensor of control point vector row matrices in the basis.

As another example alternative to obtaining an intermediate result tensor having vector rows and then multiplying the intermediate result tensor by the matrix of polynomial basis vector rows of the second parameter, the matrix of polynomial basis vector rows of the first parameter, the tensor of control point vector row matrices and the matrix of polynomial basis vector rows of the second parameter may be multiplied through all at once using a batch operation.

To reduce the time required to evaluate a surface element, processing tasks can divided for performing in parallel or contemporaneously. One or more of the multiplying the basis matrix having vector coefficient rows by the tensor of control point matrices having vector rows, the evaluating the polynomial basis vector at the number of steps in the first parameter and the evaluating the polynomial basis vector at the number of steps in the second parameter may be performed in parallel with or contemporaneously with one or more others of the multiplying the basis matrix having vector coefficient rows by the tensor of control point matrices having vector rows, the evaluating the polynomial basis vector at the number of steps in the first parameter and the evaluating the polynomial basis vector at the number of steps in the second parameter is performed on one or more other processing cores.

One or more of the product of the basis matrix having vector coefficient rows and the tensor of surface element control point matrices having vector rows, the product of the tensor of surface element control point matrices with basis-changed rows and the basis matrix having vector coefficient rows, the product of the matrix of polynomial basis vector rows of the first parameter and the tensor of control point vector row matrices in the basis and the product of the intermediate result tensor having vector rows and the matrix of polynomial basis vector rows of the second parameter may be computed by performing fused multiply-adds and/or such that a plurality of multiplications are performed in a simultaneous multiply operation and the results are added in an accumulation operation.

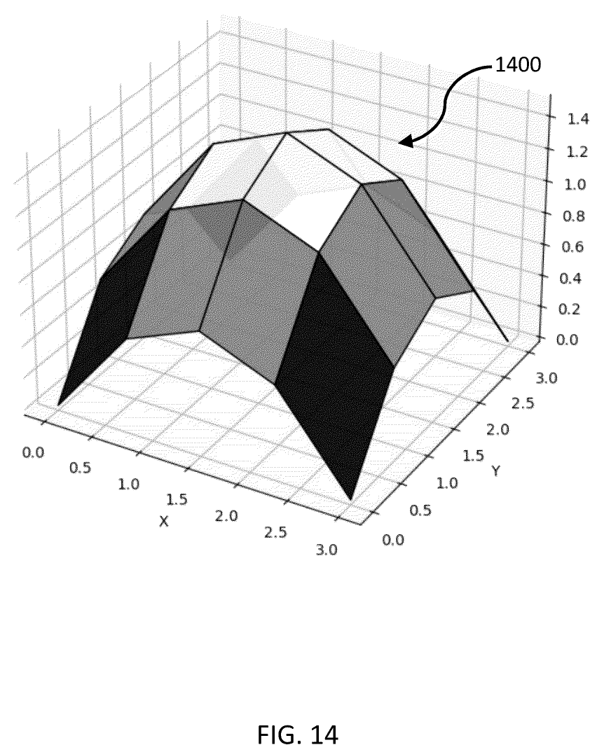

At 870, surface element points of the tensor of surface element point matrices having vector rows are rendered at a display. FIG. 14 illustrates the evaluated surface points 1400 connected by surface segments and rendered as graphics. The actions described with reference to FIGS. 8A & 8B are merely examples and other alternatives can also be provided where one or more actions are added, one or more actions are removed, or one or more actions are provided in a different sequence without departing from the scope of the claims herein.

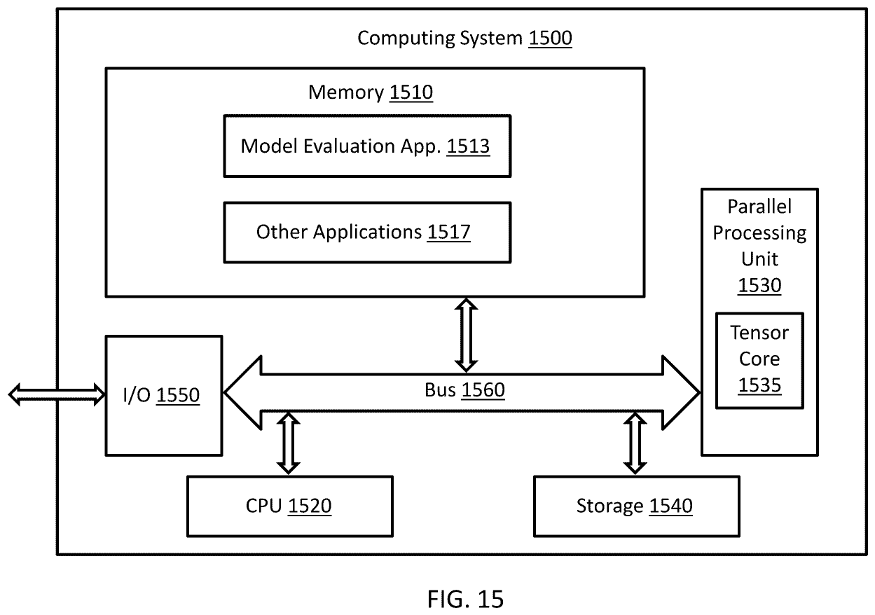

Disclosed methods for evaluating curve elements and/or surface elements may be suitable for use in association with any of a variety of systems. Similarly, disclosed methods may employ any of a variety of systems to perform actions associated with the methods. FIG. 15 schematically illustrates various components of an example computing system 1500 suitable for use in association with disclosed methods for evaluating a curve element or surface element of a computer model.

System 1500 may include, but is not limited to, a memory 1510, computing hardware such as a processor or CPU 1520, a parallel processing unit 1530, a storage 1540, Input/Output (I/O) devices 1550, and a system bus 1560 that operatively couples various components of system 1500 including memory 1510, CPU 1520, parallel processing unit 1530, storage 1540 and I/O devices 1550. System 1500 also includes a power source (not shown) for supplying electrical power to the various components of system. The power source may, for example, include a rechargeable battery.

I/O devices 1550 may include a display screen for presenting graphical images to a user of the system. The graphical images may represent computer models, surfaces, curves and/or points. In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a pen. Additionally or alternatively, I/O devices 1550 include a mouse or a joystick that is operable to receive inputs corresponding to clicking, pointing, and/or moving a pointer object on the graphical user interface. I/O devices 1550 may also include a keyboard that is operable to receive inputs corresponding to pushing certain buttons on the keyboard. Additionally, I/O devices 1550 may also include a microphone for receiving an audio input from the user, and a speaker for providing an audio output to the user.

Furthermore, I/O devices 1550 may include a network interface which optionally allows CPU 1520 to download points, curves, surfaces, 3D models or descriptions of any of these from a server or other source, for example, via a communication network. Conversely, the network interface optionally allows CPU 1520 to upload points, curves, surfaces, 3D models or descriptions of any of these to a server. Moreover, the network interface optionally allows system 1500 to communicate with other computing systems.

Memory 1510 stores an application 1513 for evaluating computer models as well as other programs 1517. Applications 1513 may be, for example, parts of a software product or products associated with a computer model evaluation service provided by system 1500. Programs 1517 may include one or more applications, modules, platforms or APIs.

Executing the software product on CPU 1520 and/or parallel processing unit 1530, in part, results in generating and rendering a graphical user interface on a display screen. The graphical user interface is configured to facilitate user interactions with the computer model evaluation service. The network interface may allow CPU 1520 to access a server to update the software product and/or download one or more new software products associated with the computer model evaluation service.

Memory 1510 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

CPU 1520 is capable of processing computer-readable instructions provided by various applications including a computer model evaluation application 1513 and other programs 1517. CPU 1520 processes the computer-readable instructions in order to execute various actions associated therewith. CPU 1520 may be a serial processor or may have some parallel processing capabilities.

Parallel processing unit 1530 may be of a variety that is capable of processing multiple threads in parallel. Parallel processing unit 1530 may be capable of processing any number of threads contemporaneously or simultaneously and may employ any of a variety of classes of parallel processing including but not limited to multi-core processing, symmetric multiprocessing, distributed computing, cluster computing, massively parallel computing, grid computing, cloud computing, tensor processing and combinations thereof. For tensor processing, a tensor core 1535 may be provided. Parallel processing unit 1530 may execute actions in accordance with instructions provided in applications such as 1513 and programs 1517 and/or may execute actions assigned by CPU 1520 in accordance with applications such as 1513 and programs 1517. Programs 1517 may facilitate use by application 1514 of parallel processing unit 1530. In an example, CUDA is implemented on system 1500 and/or parallel processing unit 1530.

Storage 1540 is configured to contain or otherwise hold curve element control point matrices having vector rows, surface element control point matrices having vector rows, basis matrices having vector coefficient rows and other descriptive data for 3D computer models.

Application 1513 for evaluating computer models such as 3D models, 2D models or elements thereof may be configured to receive, from storage 1540, I/O 1550 or an associated network interface, a description for each of the models or elements thereof. The models or elements thereof may be described in a parameter space and/or object space. In an example, the models or elements thereof are provided in NURBs formations, Ferguson formations, Hermite formations, Catmull-Rom formulations, Lagrange formulations, Bezier formulations of the curve element or a combination of these with the associated control points and/or knots.

CPU 1520 and/or parallel processing unit 1530 are configured, for example by application 1513, to use the descriptions to evaluate curve elements and surface elements of models such as 3D computer models. CPU 1520 and/or parallel processing unit 1530 are configured to multiply a basis matrix having vector coefficient rows by the curve element control point matrix having vector rows to obtain a control point basis matrix having vector rows, to evaluate a polynomial basis vector at a number of parameter steps to produce a polynomial basis matrix having vector rows and to multiply the polynomial basis matrix having vector rows by the control point basis matrix having vector rows to obtain a curve element point matrix having vector rows. CPU 1520 and/or parallel processing unit 1530 may be further configured to, at a display, render curve element points of the curve element point matrix having vector rows.

CPU 1520 and/or parallel processing unit 1530 may multiply a matrix of Bernstein basis vector coefficient rows by the curve element control point matrix having vector rows.

CPU 1520 and/or parallel processing unit 1530 may perform one or more tasks on one or more processing cores while performing one or more other tasks on one or more other processing cores. CPU 1520 and/or parallel processing unit 1530 may multiply the basis matrix having vector coefficient rows by the curve element control point matrix having vector rows on one or more processing cores while evaluating the polynomial basis vector at the number of parameter steps on one or more other processing cores. CPU 1520 and/or parallel processing unit 1530 may obtain one or more components of the control point basis matrix having vector rows with one or more processing cores while obtaining one or more other components of the control point basis matrix having vector rows with one or more other processing cores. CPU 1520 and/or parallel processing unit 1530 may evaluate the polynomial basis vector at one of the parameter steps with one or more processing cores while evaluating the polynomial basis vector at one or more others of the parameter steps with one or more other processing cores. CPU 1520 and/or parallel processing unit 1530 may obtain one or more components of the curve element point matrix having vector rows with one or more processing cores while obtaining one or more other components of the curve element point matrix having vector rows with one or more other processing cores.

CPU 1520 and/or parallel processing unit 1530 may be configured by, for example by application 1513, to use the descriptions to evaluate surface elements of models such as 3D computer models. CPU 1520 and/or parallel processing unit 1530 may be configured to multiply a basis matrix having vector coefficient rows by the tensor of surface element control point matrices having vector rows to obtain a tensor of surface element control point matrices having basis-changed vector rows, to multiply the tensor of surface element control point matrices with basis-changed vector rows by the basis matrix having vector coefficient rows to obtain a tensor of surface element control point vector row matrices in the basis, to evaluate a polynomial basis vector at a number of steps in a first parameter to produce a matrix of polynomial basis vector rows of the first parameter, to evaluate the polynomial basis vector at a number of steps in a second parameter to produce a matrix of polynomial basis vector rows of the second parameter, to multiply the matrix of polynomial basis vector rows of the first parameter by the tensor of surface element control point vector row matrices in the basis to obtain an intermediate result tensor having vector rows and to multiply the intermediate result tensor having vector rows by the matrix of polynomial basis vector rows of the second parameter to obtain a tensor of surface element control point matrices having vector rows. The processor may be further configured to, at a display, render surface element points of the tensor of surface element point matrices having vector rows.

CPU 1520 and/or parallel processing unit 1530 may multiply a matrix of Bernstein basis vector coefficient rows by the tensor of control point matrices having vector rows. CPU 1520 and/or parallel processing unit 1530 may multiply the tensor of control points with basis-changed rows by a matrix of Bernstein basis vector coefficient rows.

Again, CPU 1520 and/or parallel processing unit 1530 may perform one or more tasks on one or more processing cores while performing one or more other tasks on one or more other processing cores. CPU 1520 and/or parallel processing unit 1530 perform one or more of the multiplying the basis matrix having vector coefficient rows by the tensor of control point matrices having vector rows, the evaluating the polynomial basis vector at the number of steps in the first parameter and the evaluating the polynomial basis vector at the number of steps in the second parameter on one or more processing cores while performing one or more others of the multiplying the basis matrix having vector coefficient rows by the tensor of control point matrices having vector rows, the evaluating the polynomial basis vector at the number of steps in the first parameter and the evaluating the polynomial basis vector at the number of steps in the second parameter on one or more other processing cores.

CPU 1520 and/or parallel processing unit 1530 may obtain one or more components of the tensor of control point matrices having basis-changed vector rows with one or more processing cores while obtaining one or more other components of the tensor of control point matrices having basis-changed vector rows with one or more other processing cores.

CPU 1520 and/or parallel processing unit 1530 may multiply the tensor of control points with basis-changed rows by the basis matrix having vector coefficient rows by obtaining one or more components of the tensor of control point vector row matrices in the basis with one or more processing cores while obtaining one or more other components of the tensor of control point vector row matrices in the basis with one or more other processing cores.

CPU 1520 and/or parallel processing unit 1530 may evaluate the polynomial basis vector at one or more of the parameter steps with one or more processing cores while evaluating the polynomial basis vector at one or more others of the parameter steps with one or more other processing cores.

CPU 1520 and/or parallel processing unit 1530 may evaluate the polynomial basis vector at one or more of the parameter steps with one or more processing cores while evaluating the polynomial basis vector at one or more others of the parameter steps with one or more other processing cores.

Further, the polynomial basis vector may be evaluated at one or more of the parameter steps in the first parameter space with one or more processing cores while the polynomial basis vector is evaluated at one or more of the parameter steps in the second parameter space with one or more other processing cores.

CPU 1520 and/or parallel processing unit 1530 may obtain one or more components of the intermediate result tensor having vector rows with one or more processing cores while obtaining one or more other components of the intermediate result tensor having vector rows with one or more other processing cores.

CPU 1520 and/or parallel processing unit 1530 may obtain one or more components of the tensor of surface element point matrices having vector rows with one or more processing cores while obtaining one or more other components of the tensor of surface element point matrices having vector rows with one or more other processing cores.

The computing system 1500 is optionally implemented by way of at least one of: a mobile phone, a smart telephone, an MID, a tablet computer, a UMPC, a phablet computer, a PDA, a web pad, a PC, a handheld PC, a laptop computer, a desktop computer, an NAS device, a large-sized touch screen with an embedded PC, and an interactive entertainment device, such as a game console, a TV set and an STB.

FIG. 15 illustrates a mere example, which should not unduly limit the scope of the claims herein. It is to be understood that the specific designation for the computing system is provided as an example and is not to be construed as limiting the computing system to specific numbers, types, or arrangements of modules and/or components of the computing system. A person skilled in the art will recognize many variations, alternatives, and modifications of embodiments of the present disclosure.

Embodiments of the present disclosure also provide a computer program product that includes a non-transitory or non-transient computer-readable storage medium storing computer-executable code and/or computer readable instructions for evaluating a curve element of a 3D model and/or for evaluating for evaluating a surface element of a 3D model. The computer readable instructions for evaluating a curve element of a 3D model and/or for evaluating for evaluating a surface element of a 3D model may be implemented as model evaluation application 1513 and vice versa.

The code and/or instructions, when executed, are configured to perform the actions of methods for evaluating a curve element of a 3D model and/or evaluating a surface element of a 3D model as described above. As actions of the disclosed methods may be provided in different sequences, so the computer-executable code and/or computer readable instructions may be configured to provide a service having a different sequence of actions from those explicitly set forth above. In some examples, the code may be downloaded from a software application store, for example, from an “App store”, to a computing system or other data processing unit.

Embodiments of the present disclosure are susceptible to being used for various purposes, including, though not limited to, enabling users to speed up evaluations of 3D models and make them more accurate. Tested for a million parameter values, over a series of cubic and quartic curves, evaluations on a CPU took 0.003 seconds on average while taking 0.00066 seconds on a GPU which is more than an order of magnitude faster. CAD/CAM surface operations such as intersections, rendering, offsetting, blending and trimming will be supported, facilitated and/or expedited by disclosed methods, systems and program products.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A computer-implemented method for evaluating a curve element of a 3D model with improved accuracy, comprising:
providing a curve element of a 3D model in terms of a polynomial basis vector and a matrix of curve element control points, the matrix of curve element control points having vector rows;
multiplying a basis matrix having vector coefficient rows by the matrix of curve element control points to obtain a control point basis matrix having vector rows;
evaluating the polynomial basis vector at a number of parameter steps to produce a polynomial basis matrix having vector rows;
multiplying the polynomial basis matrix by the control point basis matrix to obtain a matrix of curve element points having vector rows; and
presenting graphical images of the curve element by rendering points of the matrix of curve element points at a display.

2. The computer-implemented method as set forth in claim 1, wherein the multiplying the basis matrix by the curve element control point matrix further comprises obtaining one or more components of the control point basis matrix in parallel with obtaining one or more other components of the control point basis matrix.

3. The computer-implemented method as set forth in claim 1, wherein the evaluating the polynomial basis vector at the parameter steps further comprises evaluating the polynomial basis vector at one of the parameter steps in parallel with evaluating the polynomial basis vector at another of the parameter steps.

4. (canceled)

5. (canceled)

6. A computer-implemented method for evaluating a surface element of a 3D model with improved accuracy, comprising:
providing a surface element of a 3D model in terms of a polynomial basis vector and a tensor of surface element control point matrices, the control point matrices having vector rows;
multiplying a basis matrix having vector coefficient rows by the tensor of surface element control point matrices to obtain a tensor of surface element control point matrices having basis-changed vector rows;
multiplying the tensor of surface element control point matrices with basis-changed vector rows by the basis matrix to obtain a tensor of surface element control point vector row matrices in the basis;
evaluating the polynomial basis vector at a number of steps in a first parameter to produce a matrix of polynomial basis vector rows of the first parameter;
evaluating the polynomial basis vector at a number of steps in a second parameter to produce a matrix of polynomial basis vector rows of the second parameter;
multiplying the matrix of polynomial basis vector rows of the first parameter by the tensor of control point vector row matrices in the basis to obtain an intermediate result tensor having vector rows;
multiplying the intermediate result tensor having vector rows by the matrix of polynomial basis vector rows of the second parameter to obtain a tensor of surface element point matrices having vector rows; and
presenting graphical images of the surface element by, at a display, rendering points of the tensor of surface element point matrices.

7. The method as set forth in claim 6, wherein the multiplying the basis matrix having by the tensor of surface element control point matrices further comprises obtaining one or more components of the tensor of control point matrices having basis-changed vector rows in parallel with obtaining one or more other components of the tensor of control point matrices having basis-changed vector rows.

8. The method as set forth in claim 6, wherein the multiplying the tensor of control points with basis-changed rows by the basis matrix further comprises obtaining one or more components of the tensor of control point vector row matrices in the basis in parallel with obtaining one or more other components of the tensor of control point vector row matrices in the basis.

9. The computer-implemented method as set forth in claim 6, wherein the evaluating the polynomial basis vector at the parameter steps in the first parameter further comprises evaluating the polynomial basis vector at one of the parameter steps in parallel with evaluating the polynomial basis vector at another of the parameter steps in the first parameter.

10. The computer-implemented method as set forth in claim 9, wherein the evaluating the polynomial basis vector at the parameter steps in the second parameter further comprises evaluating the polynomial basis vector at one of the parameter steps in parallel with evaluating the polynomial basis vector at another of the parameter steps in the second parameter.

11. The computer-implemented method as set forth in claim 6, wherein the multiplying the matrix of polynomial basis vector rows of the first parameter by the tensor of control point vector row matrices in the basis further comprises obtaining one or more components of the intermediate result tensor having vector rows in parallel with obtaining one or more other components of the intermediate result tensor having vector rows.

12. The computer-implemented method as set forth in claim 6, wherein the multiplying the intermediate result tensor having vector rows by the matrix of polynomial basis vector rows of the second parameter further comprises obtaining one or more components of the tensor of surface element point matrices having vector rows in parallel with obtaining one or more other components of the tensor of surface element point matrices having vector rows.

13. (canceled)

14. A system for evaluating a curve element of a 3D model with improved accuracy, comprising:
a memory having program instructions stored thereto;
a storage containing:
a curve element of a 3D model in terms of a polynomial basis vector and a matrix of curve element control points, the matrix of curve element control points having vector rows; and
a basis matrix having vector coefficient rows;
having a plurality of cores configured for parallel processing, a processor configured to run a program in accordance with the program instructions in order to:
multiply the basis matrix having vector coefficient rows by the matrix of curve element control points to obtain a control point basis matrix having vector rows;
evaluate the polynomial basis vector at a number of parameter steps to produce a polynomial basis matrix having vector rows; and
multiply the polynomial basis matrix by the control point basis matrix to obtain a matrix of curve element points having vector rows; and
present graphical images of the curve element by rendering points of the matrix of curve element points at a display.

15. The system as set forth in claim 14, wherein the processor is further configured to multiply the basis matrix by the curve element control point matrix by obtaining one or more components of the control point basis matrix having vector rows with one or more of the processing cores while obtaining one or more other components of the control point basis matrix having vector rows with one or more others of the processing cores.

16. The system as set forth in claim 14, wherein the processor is further configured to evaluate the polynomial basis vector at one of the parameter steps with one or more processing cores while evaluating the polynomial basis vector at one or more others of the parameter steps with one or more other processing cores.

17. The system as set forth in claim 14, wherein the processor is further configured to multiply the polynomial basis vector by the control point basis matrix by obtaining one or more components of the matrix of curve element points with one or more processing cores while obtaining one or more other components of the matrix of curve element points with one or more other processing cores.

18. (canceled)

19. A system for evaluating a surface element of a 3D model with improved accuracy, comprising:
a memory having program instructions stored thereto;
a storage containing:
a surface element of a 3D model in terms of a polynomial basis vector and a tensor of control point matrices, the control point matrices having vector rows; and
a basis matrix having vector coefficient rows;
having a plurality of cores configured for parallel processing, a processor configured to run a program in accordance with the program instructions in order to:
multiply a basis matrix having vector coefficient rows by the tensor of surface element control point matrices to obtain a tensor of surface element control point matrices having basis-changed vector rows;
multiply the tensor of surface element control point matrices with basis-changed vector rows by the basis matrix to obtain a tensor of surface element control point vector row matrices in the basis;
evaluate the polynomial basis vector at a number of steps in a first parameter to produce a matrix of polynomial basis vector rows of the first parameter;
evaluate the polynomial basis vector at a number of steps in a second parameter to produce a matrix of polynomial basis vector rows of the second parameter;
multiply the matrix of polynomial basis vector rows of the first parameter by the tensor of surface element control point vector row matrices in the basis to obtain an intermediate result tensor having vector rows;
multiply the intermediate result tensor by the matrix of polynomial basis vector rows of the second parameter to obtain a tensor of surface element point matrices having vector rows; and
present graphical images of the surface element by, at a display, rendering points of the tensor of surface element point matrices.

20. The system as set forth in claim 19, wherein the processor is further configured to multiply the basis matrix by the tensor of control point matrices by obtaining one or more components of the tensor of control point matrices having basis-changed vector rows with one or more processing cores while obtaining one or more other components of the tensor of control point matrices having basis-changed vector rows with one or more other processing cores.

21. The system as set forth in claim 19, wherein the processor is further configured to multiply the tensor of control points with basis-changed rows by the basis matrix by obtaining one or more components of the tensor of control point vector row matrices in the basis with one or more processing cores while obtaining one or more other components of the tensor of control point vector row matrices in the basis with one or more other processing cores.

22. The system as set forth in claim 19, wherein the processor is further configured to evaluate the polynomial basis vector at the parameter steps in the first parameter by evaluating the polynomial basis vector at one of the parameter steps with one or more processing cores while evaluating the polynomial basis vector at another of the parameter steps with one or more other processing cores.

23. The system as set forth in claim 22, wherein the processor is further configured to evaluate the polynomial basis vector at the parameter steps in the second parameter by evaluating the polynomial basis vector at one of the parameter steps with one or more processing cores while evaluating the polynomial basis vector at another of the parameter steps with one or more other processing cores.

24. The system as set forth in claim 19, wherein the processor is further configured to multiply the matrix of polynomial basis vector rows of the first parameter by the tensor of control point vector row matrices in the basis by obtaining one or more components of the intermediate result tensor with one or more processing cores while obtaining one or more other components of the intermediate result tensor with one or more other processing cores.

25. The system as set forth in claim 19, wherein the processor is further configured to multiply the intermediate result tensor by the matrix of polynomial basis vector rows of the second parameter by obtaining one or more components of the tensor of surface element point matrices having vector rows with one or more processing cores while obtaining one or more other components of the tensor of surface element point matrices having vector rows with one or more other processing cores.

26. The computer-implemented method as set forth in claim 1, wherein the multiplying the polynomial basis matrix by the control point basis matrix further comprises multiplying a first component of polynomial basis matrix by a first component of the control point basis matrix in parallel with multiplying one or more other components of the polynomial basis matrix by one or more other components of the control point basis matrix.

27. The computer-implemented method as set forth in claim 6, wherein multiplying the matrix of polynomial basis vector rows of the first parameter by the tensor of control point vector row matrices in the basis further comprises:
multiplying a first component of the matrix of polynomial basis vector rows of the first parameter by a first component of the tensor of control point vector row matrices in parallel with multiplying one or more other components of the matrix of polynomial basis vector rows of the first parameter by one or more other components of the tensor of control point vector row matrices; and
wherein multiplying the intermediate result tensor having vector rows by the matrix of polynomial basis vector rows of the second parameter to obtain a tensor of surface element point matrices having vector rows further comprises:
multiplying a first component of the matrix of polynomial basis vector rows of the second parameter by a first component of the tensor of control point vector row matrices in parallel with multiplying one or more other components of the matrix of polynomial basis vector rows of the second parameter by one or more other components of the tensor of control point vector row matrices.

28. The system as set forth in claim 14, wherein the processor is configured to multiply the polynomial basis matrix by the control point basis matrix by, part, multiplying a first component of polynomial basis matrix by a first component of the control point basis matrix on a first of the cores while multiplying one or more other components of the polynomial basis matrix by one or more other components of the control point basis matrix on a second of the cores.

29. The system as set forth in claim 19, wherein:
the processor is configured to multiply the matrix of polynomial basis vector rows of the first parameter by the tensor of control point vector row matrices in the basis by multiplying a first component of the matrix of polynomial basis vector rows of the first parameter by a first component of the tensor of control point vector row matrices on a first one of the cores while multiplying one or more other components of the matrix of polynomial basis vector rows of the first parameter by one or more other components of the tensor of control point vector row matrices on a second one of the cores; and
the processor is configured to multiply the intermediate result tensor having vector rows by the matrix of polynomial basis vector rows of the second parameter to obtain a tensor of surface element point matrices having vector rows by multiplying a first component of the matrix of polynomial basis vector rows of the second parameter by a first component of the tensor of control point vector row matrices on a first one of the cores multiplying one or more other components of the matrix of polynomial basis vector rows of the second parameter by one or more other components of the tensor of control point vector row matrices on a second one of the cores.
